(19) United States
(12) Patent Application Publication
(10) Pub. No.: US 2025/0239709 A1
(43) Pub. Date: Jul. 24, 2025

(54) INSERT ELEMENT FOR A BATTERY MODULE, AND BATTERY MODULE

(71) Applicant: Parker Hannifin EMEA S.à.r.l., Etoy (CH)

(72) Inventor: Stefan REICHLE, Bietigheim-Bissingen (DE)

(73) Assignee: Parker Hannifin EMEA S.à.r.l., Etoy (CH)

(21) Appl. No.: 19/173,930

(22) Filed: Apr. 9, 2025

Related U.S. Application Data
(63) Continuation of application No. PCT/EP2023/078080, filed on Oct. 10, 2023.

(30) Foreign Application Priority Data
Oct. 12, 2022 (DE) 10 2022 126 590.0

(51) Int. Cl. H01M 50/242; H01M 50/211; H01M 50/291; H01M 50/293

(52) U.S. Cl. CPC H01M 50/242; H01M 50/291; H01M 50/293; H01M 50/211

(57) ABSTRACT

The present disclosure relates to an insert element for insertion between two adjacent battery cells of a battery module, and to a battery module of this type. In order to improve insert elements of this type, in particular with regard to the flexibility of their use and their configuration, an insert element is proposed comprising two rigid cover plates and an intermediate layer which is arranged between the two cover plates, can be compressed elastically, and is constructed from a multiplicity of individual compression elements which are arranged distributed over the entire intermediate layer. The compression elements are each configured at least partially hose-shaped or tube-shaped, have at least one through bore in longitudinal direction and have one or more predetermined bending points in a region between the cover plates which move, in the case of compression of the intermediate layer by way of reduction of the spacing between the cover plates, in a direction transversely with respect to a connecting line between the cover plates.

### CROSS REFERENCE TO RELATED APPLICATIONS

This application is a continuation of international patent application PCT/EP2023/078080, filed on Oct. 10, 2023, designating the U.S., which international patent application has been published in German language and claims priority from German patent application DE 10 2022 126 590.0, filed on Oct. 12, 2022. The entire contents of these priority applications are incorporated herein by reference.

### BACKGROUND

The present disclosure relates to an insert element for insertion between two adjacent battery cells of a battery module, and to a corresponding battery module.

Solid-state battery cells change their volume/breathe depending on the charge level. Therefore, solid-state battery cells are housed in so-called pouch cells (housings having a flexible structure). To prevent cracks in the battery's solid electrolyte due to volume changes, solid-state batteries must be kept under constant load. Non-solid-state battery cells can also expand due to temperature fluctuations or damage within the cell. For this reason, swelling pads in the form of deformable cushions are placed between the battery cells of a battery stack to compensate for volume changes and to create a defined load on the battery cells.

Such a swelling pad is known, for example, from US 2022/0037714 A1. This describes a battery module having a cell stack with a plurality of battery cells and at least one pad arranged between adjacent battery cells. The pad comprises a pair of intumescent absorption pads that are pressed together when the battery cell expands in volume. A heat shield pad is interposed between the pair of intumescent absorption pads, which blocks heat transfer between the adjacent battery cells and is configured to expand at or above a preset reference temperature.

### SUMMARY

Against this background, the object of the present disclosure is to improve the known solutions of swelling pads or similar means for insertion between adjacent battery cells of a battery module, in particular with regard to the flexibility of their use and design, for example to enable adjustment of the desired load profile when the adjacent battery cells expand, thus better protecting the battery cell from damage.

According to an aspect of the present disclosure there is provided an insert element for insertion between two adjacent battery cells of a battery module comprising:
two rigid cover plates and
an intermediate layer which is arranged between the two cover plates, can be compressed elastically, and is constructed from a multiplicity of individual compression elements which are arranged distributed over the entire intermediate layer, wherein the compression elements are each configured at least partially hose-shaped or tube-shaped, have at least one through bore in longitudinal direction and have one or more predetermined bending points in a region between the cover plates which move, in the case of compression of the intermediate layer by way of reduction of the spacing between the cover plates, in a direction transversely with respect to a connecting line between the cover plates.

According to another aspect of the present disclosure there is provided a battery module comprising a cell stack having a plurality of battery cells; at least one insert element according to one of the preceding claims, which is arranged between adjacent battery cells; and a module housing in which the cell stack is arranged.

The known swelling pads are usually made of foam-like materials, wherein their behavior depends mainly on the properties of the foam structure and the base material and is limited by them. There is usually no way to improve or modify the properties of swelling pads by constructive adjustments. The insert element according to the disclosure, which could also be referred to as an insert plate, swelling plate or swelling pad, has a sandwich of two cover plates (e.g. made of metal or plastic) for constant load distribution and compression elements (e.g. as elastomeric structures) in an intermediate layer for load distribution. The compression elements have predetermined bending points at which the compression elements each begin to bend and thus change their shape when the respective insert element is loaded. The predetermined bending points thus change their position under load and move, as it were, in a direction perpendicular to the connection between the cover plates. The position, number, arrangement and design of the predetermined bending points, in particular, offer a wide range of options for adapting the behavior of the insert element to the requirements of the application or customer.

In particular, the solution of using insert elements with the sandwich solution according to the disclosure gains additional degrees of freedom in the design and adaptation of the properties according to the application requirements. For example, the structure, number, arrangement and material of the compression elements can be varied and adapted to set the desired behavior. Furthermore, additional properties can be added by coating, for example the cover plates, or by other methods, for example to improve thermal conductivity, flammability risk or EMI shielding.

In a preferred embodiment, it is provided that the compression elements each have an even number of predetermined bending points, two of which are opposite each other in a direction transverse to the connecting line between the cover plates. Such a symmetrical arrangement of the predetermined bending points allows the behavior of the insert element under load and thus its load curve to be better predicted.

The predetermined bending points can be designed and arranged differently depending on the application of the insert element. In one embodiment, a predetermined bending point is formed by an indentation on a surface and/or by local material slimming and/or by forming an angle of less than 180° between the adjacent areas of the respective compression element on both sides of the predetermined bending point. Such predetermined bending points are easy to produce and effectively cause the desired buckling of the compression elements.

The cover plates are preferably arranged parallel to each other and the predetermined bending points are preferably arranged in a plane parallel to the cover plates, in particular they are arranged in a plane centered between the cover plates. However, the predetermined bending points can also be arranged in another plane or in several planes, for example if each bending element has more than two predetermined bending points. The preferably symmetrical arrangement makes it easier to predetermine the load distribution during operation.

The compression elements can be arranged separately or connected to each other. Both embodiments have advantages. Separate compression elements enable simple production (e.g. as an endless extrudate) and do not (or only slightly) interact with the neighboring element or enable targeted delayed interaction/support. This represents an additional degree of freedom in the design and enables a simpler interpretation of the course of the force-displacement curve, which represents the force on the compression element over the reduction in the thickness of the compression element. Connected compression elements enable simpler assembly, as the elements can be manufactured and assembled in one piece. Furthermore, no individual elements need to be used up (e.g. glued on) and aligned separately. Interaction with the secondary elements can also be used to adjust the course of the force-displacement curve.

In general, different compression elements can be used. Preferably, however, the compression elements are identically designed and/or identically aligned. In particular, this makes it easier and more cost-effective to manufacture the insert element.

In one embodiment, the compression elements have several continuous holes in the longitudinal direction, so that one compression element effectively has several sub-elements. This offers more options for setting the desired load distribution through the design and arrangement of the compression elements.

In such an embodiment, the compression elements can, for example, each have a central hose-shaped or tube-shaped central element and two or more laterally adjoining side elements, whereby the side elements can be connected to the central element or can come into contact with the central element and/or an adjacent compression element when the intermediate layer is compressed. This makes it possible, for example, to limit the expansion of a compression element when the distance between the cover plates is reduced and to provide support for neighboring compression elements. The load distribution can thus change to a saturated range from a certain load, e.g. as a kind of stop or if a change in the course of the force-displacement curve is desired or required from a certain compression.

Furthermore, the side elements can be designed as rod-shaped or hose-shaped or tube-shaped connecting elements between the cover plates and the central element can be hose-shaped or tube-shaped. Such a design has advantages in production, for example, as these structures can be manufactured in a continuous process (e.g. with an extruder) and the parts do not have to be manufactured in a mold having individual cavities. Both processes are possible, wherein the extrusion process has cost advantages.

In a further embodiment, it is provided that the predetermined bending points are each arranged on the surface of the connecting elements facing towards the central element and/or on the outer surface of the central element facing towards the connecting elements. In an alternative embodiment, it is provided that the predetermined bending points are each arranged on the surface of the connecting elements facing away from the central element and/or on the inner surface of the central element facing away from the connecting elements. In a further embodiment, predetermined bending points can also be provided at both points. Having these configurations, it is possible to set whether the compression element bends inwards or outwards, and thus becomes wider or narrower in the direction parallel to the cover plates. Depending on the distance between the individual elements, the bending of the structures can only be limited by bending inwards, as the next element may be too far away. The rigidity can also vary depending on the shape of the bending structure inwards or outwards.

In general, the predetermined bending points can be arranged and designed to move away from the center of the respective compression element or towards the center of the respective compression element when the intermediate layer is compressed by reducing the distance between the cover plates.

In general, the compression elements can have different shapes. In one embodiment, it is envisaged that the compression elements have a round, oval or polygonal, in particular rectangular or honeycomb, cross-section. In general, each structure has a different force-displacement characteristic and can therefore be more or less suitable for the respective application.

In one embodiment, the compression elements are flattened towards the cover plates and can lie flat against the cover plates. This prevents the compression elements from moving relative to the cover plates and slipping out of their initial position as the load increases.

The compression elements are preferably made of plastic and/or rubber to ensure a certain elasticity, and the cover plates are preferably made of plastic and/or metal to ensure a certain strength. Other materials that ensure the desired function can also be used.

The cover plates are preferably rectangular in shape and the compression elements are preferably longitudinal in shape and arranged transversely to the longitudinal direction or in the longitudinal direction of the cover plates. This facilitates manufacture and assembly.

It is understood that the above-mentioned features and those to be explained below can be used not only in the combination indicated in each case, but also in other combinations or on their own, without departing from the scope of the present disclosure.

### BRIEF DESCRIPTION OF THE DRAWINGS

Exemplary embodiments of the disclosure are shown in the following drawings and are explained in more detail in the following description. It shows:

FIG. 1 shows a perspective view of a first exemplary embodiment of an insert element according to the disclosure.

FIG. 2 shows a top view of an exemplary embodiment of a battery module according to the disclosure.

FIG. 3 shows a diagram with the course of the surface pressure over the thickness of the insert element for different folds of intermediate layers.

FIG. 4 shows a first design of a compression element in cross-section.

FIG. 5 shows a second design of a compression element in cross-section.

FIG. 6 shows a third design of a compression element in cross-section.

FIG. 7 shows a fourth design of a compression element in cross-section.

FIG. 8 shows the compression element shown in FIG. 6 in a slightly compressed state and the progression of the force on the compression element over the thickness.

FIG. 9 shows the compression element shown in FIG. 6 in a highly compressed state and the progression of the force on the compression element over the thickness.

### DESCRIPTION OF PREFERRED EMBODIMENTS

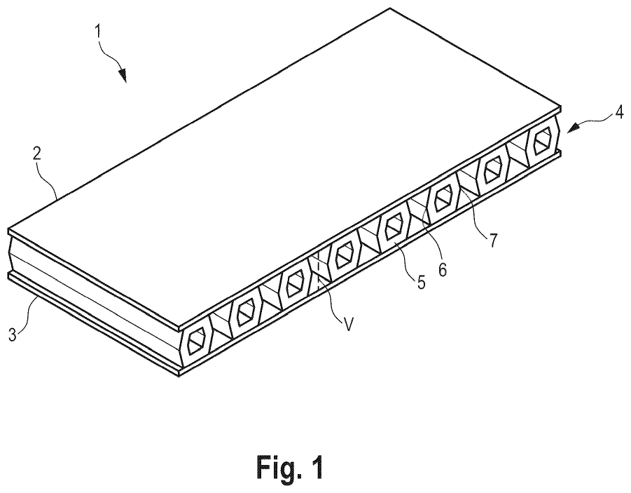

FIG. 1 shows a perspective view of a first exemplary embodiment of an insert element 1 according to the disclosure for insertion between two adjacent battery cells of a battery module. The insert element 1 is designed as a sandwich comprising two rigid cover plates 2, 3 and an intermediate layer 4 arranged between the two cover plates 2, 3. The cover plates 2, 3 are preferably relatively rigid and stable, for example made of a rigid material such as plastic or metal. The intermediate layer 4 is elastically compressible and made up of a large number of individual compression elements 5 distributed over the entire intermediate layer 4. The intermediate layer 4 is designed, for example, as an elastomer structure, in which the compression elements 5 consist essentially or entirely of plastic and/or rubber, for example.

In general, the compression elements 5 are each at least partially tube-shaped or hose-shaped. In the embodiment example shown, the compression elements 5 are designed as tubular elements that are arranged next to each other along the longitudinal direction of the insert element 1 without touching each other (in the depressurized state) and that each extend across the entire width of the insert element 1.

The compression elements 5 each have one or more (in the present exemplary embodiment two) predetermined bending points 6, 7, which are located in an area between the cover plates 2, 3 and extend over the entire length of the respective compression element 5. When the intermediate layer 4 is compressed by reducing the distance between the cover plates 2, 3, in particular as a result of an expansion of one or more adjacent battery cells, the predetermined bending points 6, 7 of one or more (preferably all) compression elements 5 move in a direction transverse to a connecting line V between the cover plates 2, 3. This allows the desired load curve to be achieved, as will be shown in more detail below.

It should be mentioned at this point that the size, number, arrangement and design of the cover plates 2, 3, compression elements 5 and predetermined bending points 6, 7 shown in FIG. 1 are merely examples. Various variations of these parameters are possible. In particular, the thickness of the cover plates 2, 3 and the size, number, design/shape, arrangement and material of the compression elements 5 can be adapted to the requirements of a specific application of the insert element 1. This provides additional degrees of freedom, regardless of the material properties, to enable a customized and improved force-displacement design, for example. In addition, suitable coating(s) of the cover plates 1, 2 and/or the compression elements 5 can enable further improvements, for example with regard to flammability, EMI shielding and/or reduction of thermal conductivity.

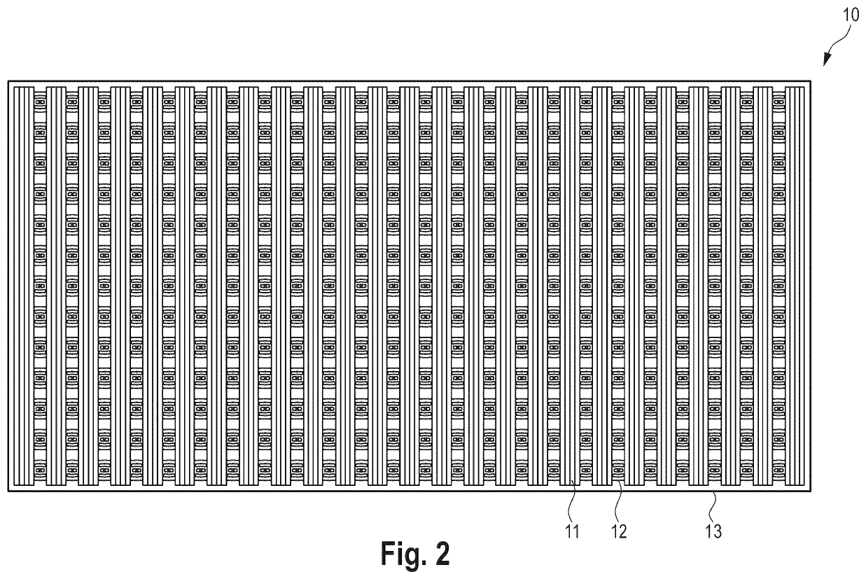

FIG. 2 shows a top view of an exemplary embodiment of a battery module 10 according to the disclosure, comprising a cell stack having a plurality of battery cells 11 (often a two-or three-digit number), wherein an insert element 12, for example of the type shown in FIG. 1, is arranged between adjacent battery cells. The cell stack is usually arranged in a module housing 13. The battery cells 11 are preferably housed as solid-state battery cells in so-called pouch cells. The insert elements 12 between adjacent battery cells 11 serve in particular to keep the battery cells under constant load during operation in order to avoid cracks in the solid electrolyte of the battery due to volume changes. The insert elements 12 compensate for volume changes in the battery cells 11 and generate a defined load on the battery cells 11.

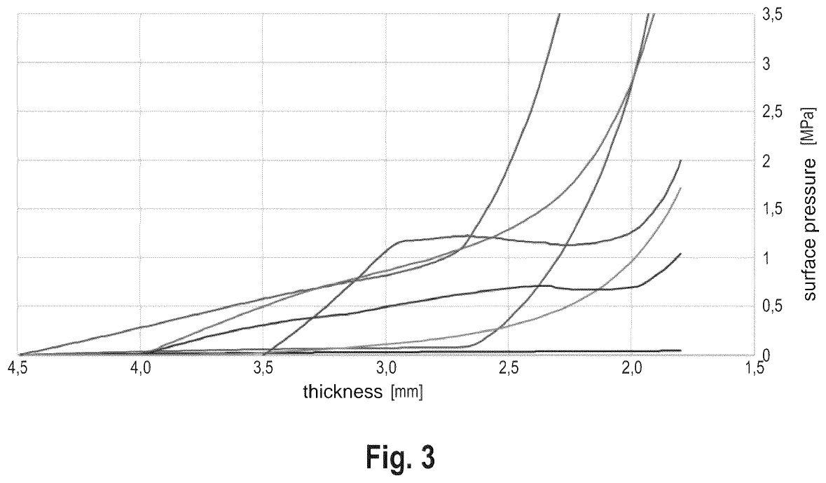

FIG. 3 shows a diagram having the course of the surface pressure (in MPa) over the thickness of the insert element (in mm) for various embodiments of intermediate layers 4. It can be seen that the course for each embodiment has a linear range, starting at the greatest thickness (in the unpressurized state) up to a certain (lower) limit thickness at a limit pressure. This illustrates that the present disclosure makes it possible to change/adapt the slope and shape of the curve as required, up to a curve having one or more steps, where there is no or only a slight increase in force in the plateau area, although the compression of the pad increases.

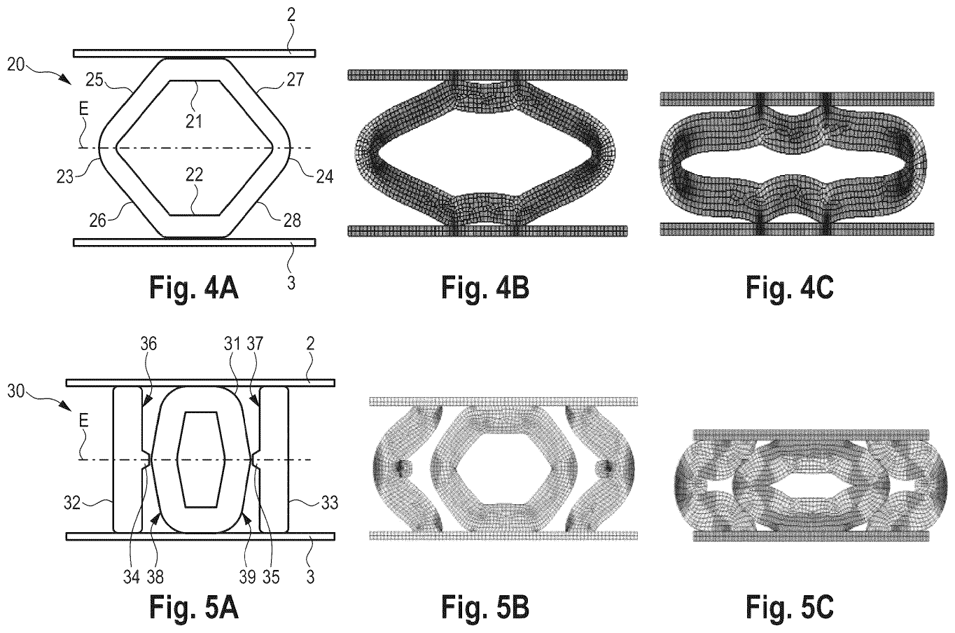

As mentioned above, the compression elements 5 can be designed in different ways. FIGS. 4 to 7 show four different designs in cross-section, in each case in the unpressurized (unmounted or mounted) initial state (FIGS. 4A, 5A, 6A, 7A), in the mounted, slightly compressed state (FIGS. 4B, 5B, 6B, 7B) and in the (almost or completely) compressed state (FIGS. 4C, 5C, 6C, 7C).

The compression element 20 shown in FIG. 4 corresponds approximately in cross-section to the compression element 5 shown in FIG. 1. It has a hexagonal (honeycomb) cross-section and is hollow on the inside. Towards the cover plates 2, 3, the compression element 20 is flattened in contact areas 21, 22 and lies flat against the cover plates 2, 3 in the depressurized state. The predetermined bending points 22, 24 lie in a central plane E, which runs approximately in the middle between and parallel to the cover plates 2, 3, and are formed as corner areas at which the adjacent areas 25, 26 or 27, 28 run at an angle to each other, for example in the range of 60° to 120°. The further the cover plates 2, 3 are pressed together, the further the predetermined bending points 23, 24 are pressed apart along the central plane E, so that the angle between the adjacent regions 25, 26 and 27, 28 is increasingly reduced, as can be seen in FIGS. 4B and 4C. The contact areas 21, 22 then also no longer lie completely flat against the cover plates 2, 3, but only lie against them in certain areas or even at certain points. This is an interplay of the stresses that arise in the individual areas of the forms during pressing. Individual areas are stretched or compressed and are hindered by contact with other elements or can move freely if there is a lack of contact. This interaction then results in the desired load profile.

The compression element 30 shown in FIG. 5 has a hose-shaped or tube-shaped central element 31 and two laterally (on opposite sides) adjoining side elements 32, 33. In this exemplary embodiment, the side elements 32, 33 are designed—in cross-section—as rod-shaped connecting elements, but can also be designed to be tubular or hose-shaped. Both the side elements 32, 33 and the central element 31 rest against the pressure plates 2, 3 in certain areas. The side elements 32, 33 are connected to the central element 31 at protruding connection points 34, 35, which are also predetermined bending points. The predetermined bending points 34, 35 are thus arranged in the central plane E in each case on a surface 36, 37 of the rod-shaped side elements 32, 33 aligned towards the central element 31. The further the cover plates 2, 3 are pressed together, the further the predetermined bending points 34, 35 (and also the adjacent point of the central element 31) are moved apart within the central plane E until the inner surfaces 36, 37 of the side elements 32, 33 and the opposite outer surfaces 38, 39 of the central element 31 are in contact with each other, as can be seen in FIG. 5C.

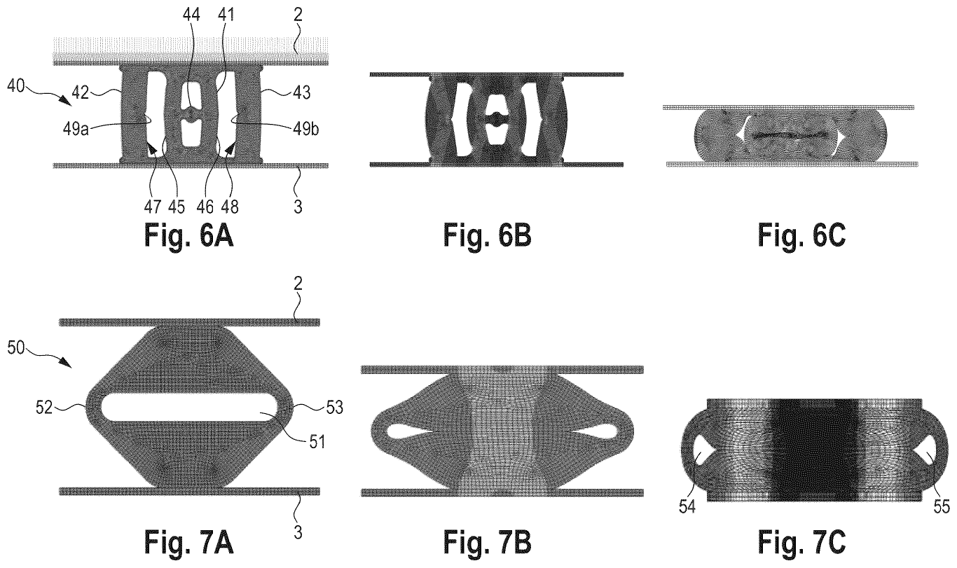

FIG. 6 shows a further embodiment of a compression element 40, which also has a central element 41 and two side elements 42, 43. In this embodiment, the central element 41 has a central connecting web 44 running parallel to the cover plates 2, 3 between the webs 45, 46 of the central element 41 running between the cover plates 2, 3. The side elements 42, 43 are connected along the cover plates 2, 3 to the webs 45, 46 of the central element 41. A predetermined bending point 49, 50 is arranged on the surface 47, 48 opposite the central element 41, approximately in the area of the central plane E in the form of a groove running in the longitudinal direction of the compression element 40 (or material constriction of the respective side element 42, 43). At this predetermined bending point, the side elements 42, 43 bend when pressure is applied to the compression element 40, so that the predetermined bending points 49a, 49b move apart. When greater pressure is applied, the central element 41 is completely compressed, as shown in FIG. 6C.

FIG. 7 shows a further embodiment of a compression element 50, which—similar to the compression element 20 shown in FIG. 4—is tubular in shape having a hexagonal cross-section. A continuous bore 51 runs in the longitudinal direction, which in this embodiment is slot-shaped, wherein the slot runs parallel to the cover plates 2, 3. Thin webs 52, 53 at the sides of the slot-shaped bore 51 form the predetermined bending points. As the pressure is applied, the slot-shaped bore 51 initially narrows and the predetermined bending points 52, 53 move apart in a direction parallel to the cover plates 2, 3. Finally, only two small lateral bores 54, 55 remain of the slot-shaped bore 51.

At this point, it should be mentioned that in the embodiments shown in FIGS. 5 and 6, when the intermediate layer is compressed, the side elements may come into contact with the central element and/or an adjacent compression element (for example with its one side element), so that the elements coming into contact can then support each other. In general, in these embodiments, the predetermined bending points can be arranged on the surface of the connecting elements that is aligned towards the central element and/or on the outer surface of the central element that is aligned towards the connecting elements. Furthermore, the predetermined bending points can each be arranged on the surface of the connecting elements facing away from the central element and/or on the inner surface of the central element facing away from the connecting elements.

It should also be mentioned that in the embodiments shown in FIGS. 4 to 7, adjacent compression elements may come into contact when the intermediate layer is compressed in order to support each other and increase stability. In general, the predetermined bending points can be arranged and designed in such a way that they move away from the center of the respective compression element (i.e. away from each other) or towards the center of the respective compression element (i.e. towards each other) when the intermediate layer is compressed by reducing the distance between the cover plates.

In summary, FIG. 4 shows a variant with a small increase in force over a wide area (flat curve) of the compression and a strong/exponential increase in force from a certain compression (i.e. with a sudden sharp increase). FIG. 5 shows a variant with a flat curve with an adjacent small plateau area over a large area of compression with a late, significant (exponential) increase in force. FIG. 6 shows a rapid increase in force up to a desired target value, followed by a large plateau phase with approximately constant force with increasing compression, followed by an exponential increase in force when a defined compression limit is reached. FIG. 7 shows a variant with a short range in which the force increases slowly with the compression, but a large increase in force is achieved relatively quickly with increasing compression.

Preferably, the cross-section of the compression elements is symmetrical, and the compression elements preferably each have an even number of predetermined bending points, two of which lie opposite each other in a direction transverse to the connecting line between the cover plates. Preferably, the cover plates are arranged parallel to each other and the predetermined bending points lie in a plane parallel to the cover plates, in particular in a plane arranged centrally between the cover plates. However, they can also lie in another plane or in several planes that run parallel to one or both cover plates.

Different designs are possible for the predetermined bending points. For example, a predetermined bending point can be formed by an indentation on a surface and/or by a local slimming of the material and/or by forming an angle of less than 180° between the adjacent areas of the respective compression element on both sides of the predetermined bending point.

The compression elements can be arranged separately or connected to each other. Preferably, identically designed and/or arranged compression elements are used, which enables simpler manufacture and assembly. Furthermore, the compression elements can have one or more continuous holes in the longitudinal direction. Different designs are also possible for the cross-section of the compression elements, such as a round, oval or polygonal, in particular rectangular or honeycomb-shaped, cross-section. There are also various corresponding design options for the cross-section of one or more holes.

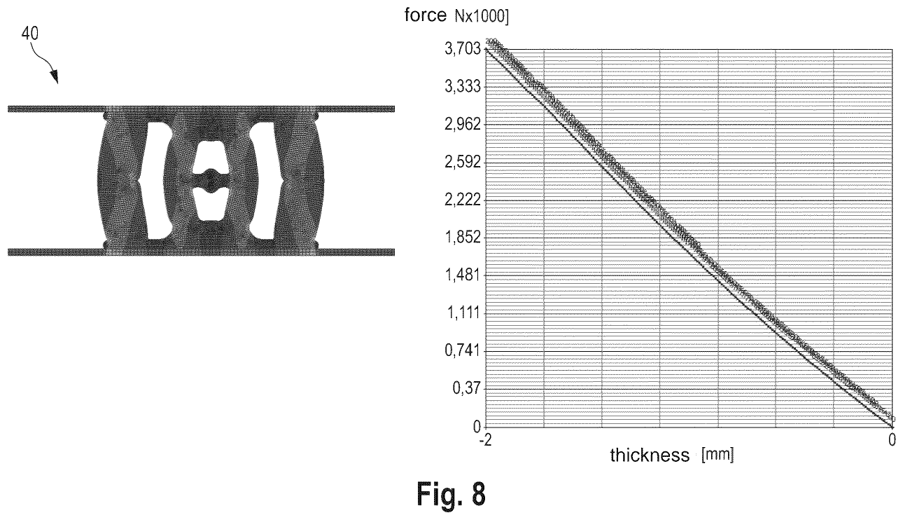

FIG. 8 shows the compression element 40 shown in FIG. 6 in the slightly compressed state shown in FIG. 6B as well as the progression (“force-displacement curve”) of the force on the compression element (in Newtons ×1000) over the reduction in the thickness of the compression element (in mm; starting at 0 corresponding to the initial state to −2 corresponding to a reduction in thickness by 2 mm). The linear progression of the curve is recognizable when the compression element 40 is compressed in this order of magnitude.

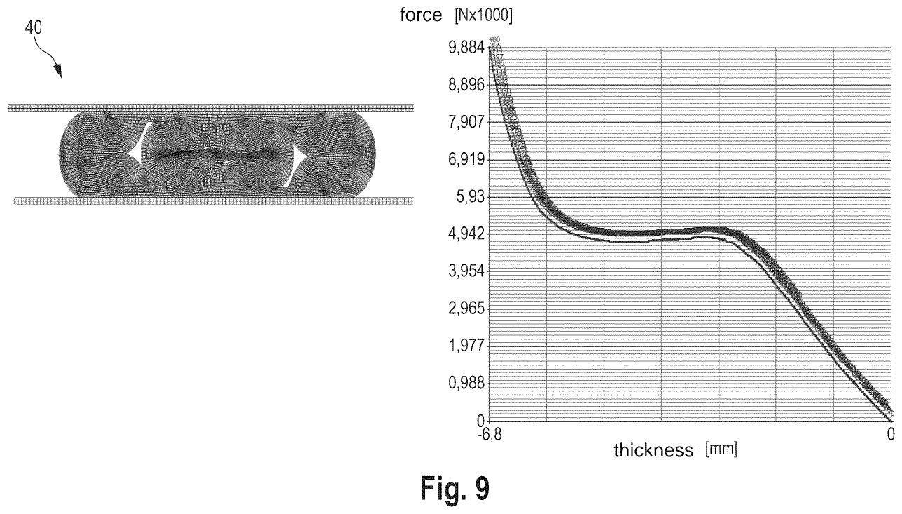

FIG. 9 shows the compression element 40 shown in FIG. 6 in the more compressed state shown in FIG. 6C as well as the progression (“force-displacement curve”) of the force on the compression element over the reduction in the thickness of the compression element (in mm; starting at 0 corresponding to the initial state to −6.8 corresponding to a reduction in thickness of 6.8 mm). When the compression element 40 is compressed in this order of magnitude, the stage or plateau phase can be recognized, in which the force remains at an almost constant level, although the compression increases.

In general, different curves for the force-displacement curve and corresponding embodiments of the insert element can be used according to the disclosure. For example, the curve can have a flat rise at the beginning followed by a sharp rise, or the course can have one or more steps and/or plateau areas, or a sharp rise at the beginning can be followed by a lower rise of the curve in phases. It may also be possible to use a curve that slopes downwards in phases and has a linear course over long distances.

The insert element according to the disclosure offers a number of advantages over the known swelling pads. These include, in particular, easier handling and manufacture and greater flexibility with regard to the structure and desired properties, which are not only dependent on the material properties of the materials used.

What is claimed is:

1. An insert element for insertion between two adjacent battery cells of a battery module, comprising:
two rigid cover plates and
an intermediate layer which is arranged between the two cover plates, can be compressed elastically, and is constructed from a multiplicity of individual compression elements which are arranged distributed over the entire intermediate layer, wherein the compression elements are each configured at least partially hose-shaped or tube-shaped, have at least one through bore in longitudinal direction and have one or more predetermined bending points in a region between the cover plates which move, in the case of compression of the intermediate layer by way of reduction of the spacing between the cover plates, in a direction transversely with respect to a connecting line between the cover plates.

2. The insert element according to claim 1,
wherein the compression elements each have an even number of predetermined bending points, of which two are located opposite each other in a direction transverse to the line connecting the cover plates.

3. The insert element according to claim 1,
wherein a predetermined bending point is formed by:
a notch on a surface, and/or
local material thinning, and/or
forming an angle of less than 180° between the regions of the respective compression element adjacent on either side of the predetermined bending point.

4. The insert element according to claim 1,
wherein the cover plates are arranged parallel to one another and the predetermined bending points are arranged in a plane parallel to the cover plates, in particular in a plane arranged centrally between the cover plates.

5. The insert element according to claim 1,
wherein the compression elements are arranged separate from one another or connected to one another.

6. The insert element according to claim 1,
wherein the compression elements are configured identically and/or aligned identically.

7. The insert element according to claim 1,
wherein the compression elements have a plurality of through bores in the longitudinal direction.

8. The insert element according to claim 1,
wherein the compression elements each have a central hose-or tube-shaped central element and two or more side elements laterally adjoining it.

9. The insert element according to claim 8,
wherein the side elements are connected to the central element or come into contact with the central element and/or an adjacent compression element upon compression of the intermediate layer.

10. The insert element according to claim 8,
wherein the side elements are configured as rod-shaped or hose-shaped or tube-shaped connecting elements between the cover plates and the central element is configured hose-shaped or tube-shaped.

11. The insert element according to claim 10,
wherein the predetermined bending points are each arranged on the surface of the connecting elements directed towards the central element and/or on the outer surface of the central element directed towards the connecting elements.

12. The insert element according to claim 10,
wherein the predetermined bending points are each arranged on the surface of the connecting elements facing away from the central element and/or on the inner surface of the central element facing away from the connecting elements.

13. The insert element according to claim 1,
wherein the predetermined bending points are arranged and designed to move away from the center of the respective compression element or in the direction of the center of the respective compression element when the intermediate layer is compressed by reducing the distance between the cover plates.

14. The insert element according to claim 1,
wherein the compression elements have a round, oval or polygonal, in particular rectangular or honeycomb, cross-section.

15. The insert element according to claim 1,
wherein the compression elements are flattened towards the cover plates and lie flat against the cover plates.

16. The insert element according to claim 1,
wherein the compression elements are made of plastic and/or rubber.

17. The insert element according to claim 1,
wherein the cover plates are made of plastic and/or metal.

18. The insert element according to claim 1,
wherein the cover plates are rectangular and the compression elements are elongated and arranged transversely to the longitudinal direction or in the longitudinal direction of the cover plates.

19. A battery module comprising:
a cell stack having a plurality of battery cells;
at least one insert element according to claim 1, which is arranged between adjacent battery cells; and
a module housing in which the cell stack is arranged.
